(19) United States
(12) Patent Application Publication
(10) Pub. No.: US 2022/0223301 A1
(43) Pub. Date: Jul. 14, 2022

(54) RADIOACTIVE POWER GENERATOR REACTIVATION SYSTEM

(71) Applicant: Wichita State University, Wichita, KS (US)

(72) Inventor: Nickolas Solomey, Wichita, KS (US)

(21) Appl. No.: 17/450,215

(22) Filed: Oct. 7, 2021

Related U.S. Application Data
(60) Provisional application No. 63/089,093, filed on Oct. 8, 2020.

(51) Int. Cl. G21B 1/21; B64G 1/42; B64G 1/66

(52) U.S. Cl. CPC G21B 1/21; B64G 1/66; B64G 1/422

(57) ABSTRACT

A radioactive power generation system is disclosed, the system comprising a radioactive power generator and a releasable antiproton containment. The radioactive power generator includes a radioisotope material. The releasable antiproton containment comprising a plurality of antiprotons contained in isolation from the radioisotope material. The releasable antiproton containment is configured to selectively release the antiprotons from the releasable antiproton containment such that the antiprotons can annihilate the radioisotope material in a fission event to reenergize the radioactive power generator.

### CROSS REFERENCE TO RELATED APPLICATIONS

The present application claims priority to U.S. Provisional Application No. 63/089,093, filed Oct. 8, 2020, which is hereby incorporated in its entirety.

### FIELD

The present disclosure generally relates to power generation systems, specifically to radioactive power generation systems.

### BACKGROUND

As space exploration continues, progress within the fields of astronomy, physics, and mathematics have made exploration of exoplanets via unmanned spacecraft more accessible. Unmanned spacecraft are well suited for observation, computation, and transmission of scientific data over large distances of space. However, missions to exoplanets such as Proxima Centauri B, which is 4.243 light years away, require greater energy production than those currently available. Previously, solar panels have been used to produce electricity for unmanned spacecraft operations in space. However, as an unmanned spacecraft's distance from the sun increases, the available solar radiation for use is drastically reduced. For example, a mission to Pluto is nearly four billion miles from the sun, making solar radiation intensity near Pluto extremely low. Further, solar panel designs for harvesting the light in deep space become unfeasible for existing launch vehicles. Similarly, existing batteries and chemical power sources cannot provide enough power for an exoplanet mission. Due to these limitations, many unmanned spacecraft utilize radioisotope thermoelectric generators (RTGs), which harness heat from radioactive decay for conversion to electrical energy. Plutonium-238 is a commonly used radioisotope in RTGs since it provides the most adequate levels heat for electrical conversion. Commonly, a heat source for an RTG can be composed of ceramic pellets of a radioisotope such as plutonium-238 dioxide. For scale, 72 pellets weigh a total of about 24 pounds, equivalently 11 kilograms and a typical space mission requires 3 to 11 kg of Plutonium-238 dioxide. RTGs, like those used in Voyager 1 and 2, add significant weight to the spacecraft. In the case of Voyager 1, the RTG added 37.7kg (−83 lbs.) to the launch weight of the space probe. Cost-cutting is a significant factor in space exploration feasibility, with NASA estimating that each additional pound of weight costs around $10,000 to launch. Additionally, the heat produced by radioisotopes diminishes with time, lowering the electrical output of RTGs to less than half their original efficiency.

Further, the United States has minimal reserves of Plutonium-238 for launches. In order to fuel launches without the use of Plutonium-238, fission of Uranium has been used via heat transfer by a heat-exchange coolant with either a static or dynamic conversion system, which transforms the Uranium into electricity. However, more research is needed to make this a feasible option. Therefore, there is a need for an alternative energy source to power space launches and a new generator system that produces a higher energy production with little to no increase in mass.

### SUMMARY

In one aspect, a radioactive power generation system is disclosed, the system comprising a radioactive power generator and a releasable antiproton containment. The radioactive power generator includes a radioisotope material. The releasable antiproton containment comprising a plurality of antiprotons contained in isolation from the radioisotope material. The releasable antiproton containment is configured to selectively release the antiprotons from the releasable antiproton containment such that the antiprotons can annihilate the radioisotope material in a fission event to reenergize the radioactive power generator.

In another aspect, a method of powering a spacecraft is disclosed. The method comprises first powering at least one electrical system of the spacecraft using radioisotope material of a radioactive power generator for an initial time interval. Next, after the initial time interval, releasing antiprotons to the radioactive power generator to induce nuclear fission of the radioisotope material and thereby reenergize the radioactive power generator.

Other objects and features of the present disclosure will be in part apparent and in part pointed out herein.

### BRIEF DESCRIPTION OF THE DRAWINGS

FIG. 1 is an elevation of a radioactive power generation system;

FIG. 2 is a cross section of a penning trap;

FIG. 3 is a is a perspective of a portion of an unmanned spacecraft; and

FIG. 4 is a cross sectional perspective of a radioactive power generator.

Corresponding reference numbers indicate corresponding parts throughout the drawings.

### DETAILED DESCRIPTION

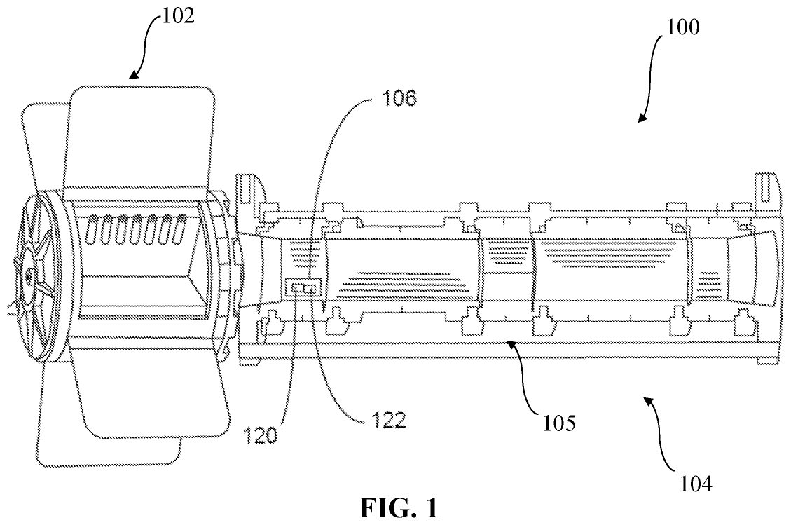

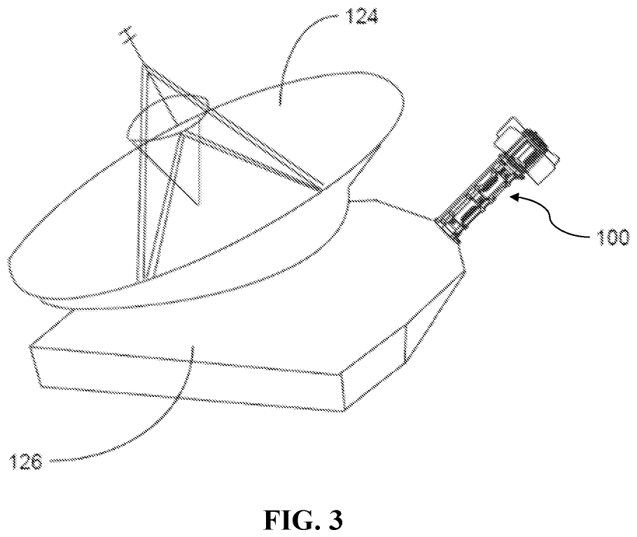

Referring to FIG. 1, a radioactive power generation system is generally indicated at reference number 100. The radioactive power generation system 100 broadly comprises a radioactive power generator 102 and a releasable antiproton containment 104. The radioactive power generator 102 comprises radioisotope material that fuels electrical power generation. Referring to FIG. 3, the radioactive power system 100 is used to power one or more electrical systems of an unmanned spacecraft 126. For example, the power generated by the radioactive power generation system 100 is used to power the electrical systems onboard the unmanned spacecraft 126, such as systems used for scientific data transmission (i.e., LIDAR and other systems). The unmanned spacecraft 126 also includes an antenna 124, which can be used to remotely signal the radioactive power system 100 as described more fully below. The unmanned spacecraft 126 may be an unmanned space probe, but nothing in this disclosure should be construed to limit the type of unmanned spacecraft being used.

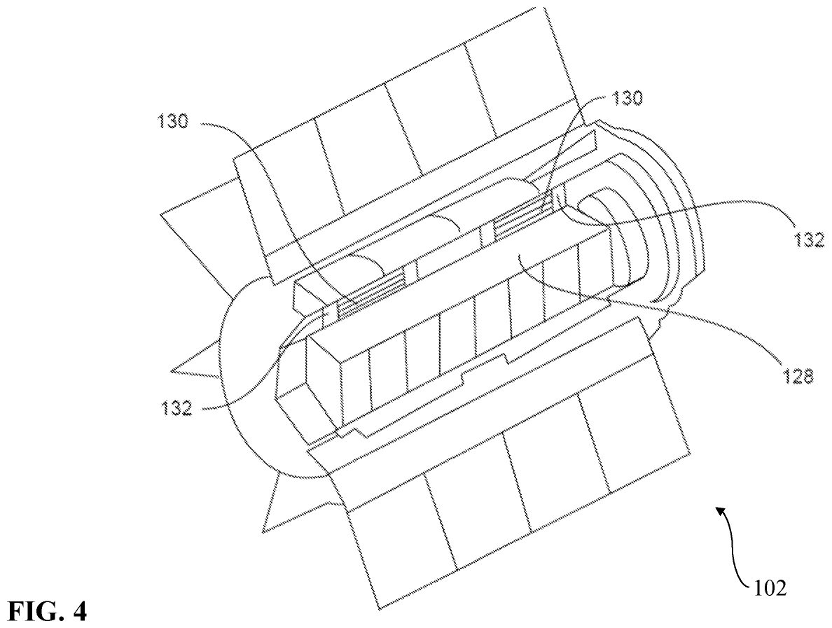

Referring to FIG. 4, the radioactive power generator 102 comprises radioisotope material 128 that fuels electrical power generation by producing heat as it radioactively decays. The illustrated radioactive power generator 102 includes an array of thermocouples 130 and heat sinks 132 disposed around the radioisotope material 128. The array of thermocouples 130 and heat sinks 132 convert the thermal energy produced in the radioactive decay into electrical energy using the Seebeck effect. The greater the temperature difference between the array of thermocouples 130 and the heat sinks 132, the greater the electrical charge produced.

In accordance with one embodiment of the present disclosure, the radioisotope 128 stored in the radioactive power generator 102 is plutonium 238, though this disclosure also contemplates that other radioisotopes may also be used. Generally, the duration of power generation for traditional radioactive thermoelectric generators (RTGs) is dependent on the half-life of the radioisotope used (i.e., plutonium 238 has a half-life of 87.7 years). The radioisotope 128 decays in a known manner inside the radioactive power generator 102 and produces heat as a byproduct. After 87 years, however, half of the plutonium 238 will have decayed, which also halves the maximum amount of heat that may be produced for conversion of electrical energy.

As described below, he inventors have discovered that it is possible to increase the power output and life of the radioactive power generation system 100 by reenergizing the radioisotope material 128 after it becomes depleted over time. More particularly, the inventors have devised the radioactive power generation system 100 to include the releasable antiproton containment 104 for the purpose of selectively inducing nuclear fission of the raidoiostope material 128 to reenergize the material, e.g., cause the thermal energy output of the material to increase.

The releaseable antiproton containment 104 broadly comprises antiprotons initially contained in isolation from the radioisotope material 128, but which can also be selectively adjusted to allow direct access of the antiprotons to the radioisotope material. Antiprotons are subatomic particles that have an equivalent mass of a proton but with a negative electric charge and oppositely directed magnetic moments. Electrons and antiprotons, while having the same charge, are fermions with different quantum numbers. Broadly speaking, the releasable antiproton containment 104 functions to extend the operating life and power output of the radioactive power generator 102. After the radioisotope material (broadly, fuel) of the radioactive power generator 102 becomes depleted, the releasable antiproton containment 104 is configured to selectively release the antiprotons from the releasable antiproton containment such that the antiprotons annihilate the radioisotope material of the radioactive power generator 102, causing fission that reenergizes the radioactive power generator 102.

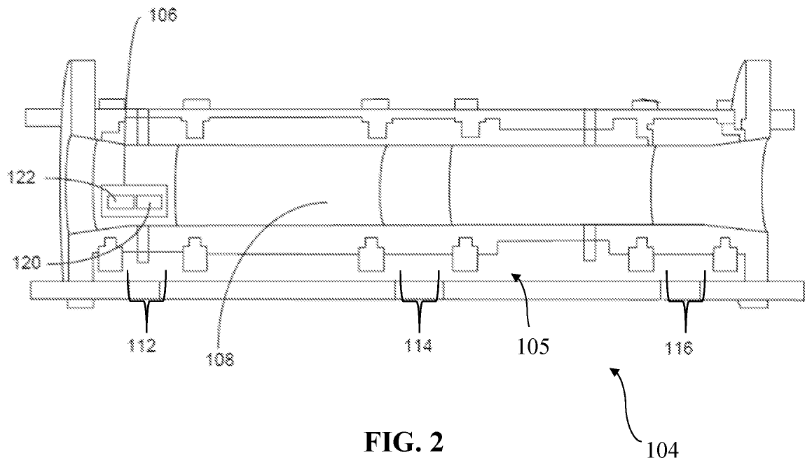

The illustrated releasable antiproton containment 104 comprises a penning trap 105 for containing the antiprotons in a magnetic field and a driver 106 configured for adjusting the penning trap to free the antiprotons from the magnetic field. Referring to FIG. 2, the penning trap 105 of the radioactive power generation system 100 is shown. The penning trap 105 includes a vacuum tube 108 and a plurality of electrodes 112, 114, 116. The penning trap 105 provides a stable containment for the charged antiprotons within the vacuum tube 108 as they oscillate within the tube, similar to how magnetic storage rings can confine circulating particle beams. The penning trap 105 uses the plurality of electrodes 112, 114, 116 to create an axial magnetic field and a quadrupole magnetic field to confine the antiprotons within the vacuum tube 108. In one embodiment, the plurality of electrodes 112, 114, 116 may be any electrostatic electrodes capable of creating an axial magnetic field and a quadrupole magnetic field. In the illustrated embodiment, the plurality of electrodes comprises a ring electrode 112, a first endcap electrode 114, and a second endcap electrode 116. Nothing in this disclosure should be construed to limit the number of electrodes that may be used, however, as fewer or greater than three electrodes are contemplated by this disclosure. The plurality of electrodes 112, 114, 116 of the penning trap 105 create, in part, the vacuum tube 108 of the penning trap. Additionally, the first endcap electrode 112 and the second endcap electrode 116 are mechanically moveable via the driver 106. In an alternative embodiment, the penning trap 105 may utilize a plurality of magnetic mirror coils (i.e. electromagnets) placed close together. Two parallel magnetic mirror coils carrying the same current in the same direction will produce a magnetic bottle between them. This magnetic bottle can be used to confine antiprotons such that the antiprotons and the magnetic mirror coils never contact.

Antiprotons can be loaded into the penning trap 105 in two ways. In a first instance, the antiprotons are created inside the penning trap 105 such that the antiprotons are trapped instantaneously within the vacuum tube 108. Antiprotons may be created within the penning trap by a variety of methods, including electron impact on a neutral atomic vapor, ablation from a surface using a pulsed laser, or photoionization of neutral atoms in a known manner. In a second instance, an antiproton can be transported into the penning trap 105 from elsewhere. The antiproton can be transmitted into the penning trap 105 by lowering the energy potential of the plurality of electrodes 112, 114, 116, as calculated from equation (1) below, inside the penning trap 105 in order to allow the antiproton into the penning trap. After the antiprotons have been introduced into the vacuum tube 108, the energy potential is then raised before the antiprotons have “bounced” or reflected back from the second endcap electrode 116. The antiprotons loaded into the trap from an outside source may be created from a laboratory (i.e. Fermilab) and then transported into the penning trap 105.

Generally, the energy potential of the plurality of electrodes 112 of the penning trap 105 can be defined by:

ϕ(r, z)=A(2z²−r²) (1)

Where r is the distance from the ring electrode 112 to a mathematically calculated center of the vacuum tube 108, and where z is the distance from the first or second endcap electrode 114, 116 to the center of the vacuum tube.

The driver 106 of the releasable antiproton containment 104 comprises a servomotor 120 and a sensing device 122. In an exemplary embodiment, the servomotor 120 includes a control circuit, a direct current motor, and a gear assembly (not shown). The sensing device 122 is configured to receive an actuating signal from the antenna 124. The servomotor is operatively connected to the first endcap electrode 114 for moving the first end cap electrode between a containment position and a release position. In the containment position, the first endcap electrode 114 contains the antiprotons in the penning trap 105, and in the release position, the first endcap electrode releases the antiprotons from the penning trap. In the illustrated embodiment, the sensing device 122 is configured to actuate the servomotor 120 to selectively move the first endcap electrode from the containment position to the release position.

In one embodiment, the sensing device 122 facilitates remote actuation of the servomotor 120. For example, in the illustrated embodiment, the sensing device 122 is operatively connected to the antenna 124 of the unmanned spacecraft 126. When the radioisotope 128 is nearing its half-life (or at any other desired time in the life of the radioisotope material), a signal is sent to the unmanned spacecraft 126, typically from a terrestrial location, and received by the antenna 124. The signal is relayed from the antenna 124 to the sensing device 122. The sensing device 122 then signal to the servomotor 120 to initiate release of antiprotons into the radioactive power generator 102. The control circuit controls the direct current motor to adjust the gear assembly and thereby move the first endcap electrode 114 from the containment position to the release position. This interrupts the axial magnetic field and the quadrupole magnetic field inside the penning trap 105 and allows the antiprotons to freely enter the radioactive power generator 102. In another embodiment of the present disclosure, the second endcap electrode 116 can also be moved, either by itself or in conjunction with the first endcap electrode 114. The release of antiprotons due to the disruption of the magnetic field induces nuclear fission with the plurality of radioisotope material 128 stored within the radioactive power generator 102. The result of the nuclear fission process is the release of energy as the antiprotons collide and annihilate with the radioisotopes 128.

The radioactive power generation system 100 is configured to generate additional power through nuclear fission (i.e., the process in which heavy atomic nuclei are split into smaller atomic nuclei). Generally, a fission event for Plutonium 238 generates two fission daughters and other products, including liberated neutrons and gamma photons (light), thus producing energy. When a low kinetic energy antiproton strikes matter, it quickly decelerates due to scattering against the matter's electrons. At thermal energies the antiproton will only penetrate a few atomic layers into the matter. When the negatively charged antiprotons decelerate to kinetic energies of a few electron Volts (eV), they displace an orbiting outer-shell electron of the matter. Due to the attraction force between the proton and the antiproton, the antiprotons quickly cascade down to the ground state and annihilate against one of the nucleons (i.e., proton or neutron) of the nucleus, creating a burst of energy, or fission event, within the radioactive power generator 102. The fission event creates a larger amount of energy than that which is produced through radioactive decay, thus creating more heat and a higher temperature differential between the array of thermocouples 130 and the heat sinks 132. This higher temperature differential produces more electrical energy (i.e., power) for use by the unmanned spacecraft 126. Due to the ability of the antiprotons to create greater amounts of energy within the radioactive power generation system 100, the amount of radioisotope 128 that needs to be stored in the unmanned spacecraft 126 may be decreased. By reducing the amount of radioisotope required for power generation, the costs associated with spacecraft launches and maintenance is significantly reduced, thus increasing feasibility of deep space exploration.

A method of powering a spacecraft 126 will now be briefly described. For an initial period of time (e.g., for a half-life of the radioisotope material 128), the radioactive power generation system 100 powers at least one electrical system of the spacecraft 126 using radioactive decay of radioisotope material 128. During this initial interval of time, the electrodes 114, 116, 112 of the releasable antiproton containment 104 generate a magnetic field that contains the antiprotons in the penning trap 105. After the initial time interval, the antiproton containment 104 releases the antiprotons to the radioactive power generator 102 to induce nuclear fission of the radioisotope material 128 and thereby reenergize the radioactive power generator. For example, the antenna 124 of the spacecraft 126 receives a signal to reenergize the generator 102 and relays the signal to the sensing device 122. In response to the release signal, the sensing device 122 actuates the driver 106, which moves the first endcap electrode 114 from the containment position to the release position and thereby releases the antiprotons from containment. Once the antiprotons are released from the penning trap 105, they induce nuclear fission of the radioisotope material 128 and thereby cause emission of thermal energy as described above. The power generator 102 uses the thermal energy to generate electricity, which powers the at least one electrical system of the spacecraft during the subsequent time interval.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A radioactive power generation system, the system comprising:
a radioactive power generator, the radioactive power generator including a radioisotope material; and
a releasable antiproton containment comprising a plurality of antiprotons contained in isolation from the radioisotope material, the releasable antiproton containment being configured to selectively release the antiprotons from the releasable antiproton containment such that the antiprotons can annihilate the radioisotope material in a fission event to reenergize the radioactive power generator.

2. The radioactive power generation system as set forth in claim 1, wherein the releasable antiproton containment comprises a penning trap.

3. The radioactive power generation system as set forth in claim 2, wherein the penning trap includes a plurality of electrodes, a plurality of antiprotons, and a vacuum tube, the plurality of electrodes configured to generate a magnetic field to contain the plurality of antiprotons within the vacuum tube.

4. The radioactive power generation system as set forth in claim 3, wherein the releasable antiproton containment comprises a driver configured to move the plurality of electrodes to release the antiprotons from the releasable antiproton containment.

5. The radioactive power generation system as set forth in claim 4, wherein the plurality of electrodes includes a ring electrode, a first endcap electrode, and a second endcap electrode.

6. The radioactive generator reactivation system as set forth in claim 5, wherein the driver is configured to move one or both of either the first endcap electrode or the second endcap electrode.

7. The radioactive generator reactivation system as set forth in claim 5, wherein the first endcap electrode, second endcap electrode, and ring electrode generate an axial magnetic field and a quadrupole magnetic field to contain the antiprotons.

8. The radioactive generator reactivation system as set forth in claim 4, wherein driver comprises a servomotor including a control circuit, a direct current motor, and a gear assembly, wherein the control circuit is configured to control the direct current motor such that the direct motor moves the gear assembly, and wherein the gear assembly is operatively connected to the plurality of electrodes for moving the plurality of electrodes.

9. The radioactive power generation system as set forth in claim 1, wherein the radioactive power generator further comprises an array of thermocouples and a heat sink, wherein energy created by the fission event creates a temperature difference between the thermocouple arrays and the heat sink by which electrical power is generated.

10. A spacecraft comprising the radioactive power generation system of claim 1.

11. The spacecraft of claim 10, further comprising one or more electrical systems powered by the radioactive power generation system.

12. The spacecraft of claim 11, further comprising an antenna configured to receive a remote release signal and to cause the releasable antiproton containment to release the antiprotons in response to the remote signal.

13. A method of powering a spacecraft, the method comprising:
powering at least one electrical system of the spacecraft using radioisotope material of a radioactive power generator for an initial time interval;
after the initial time interval, releasing antiprotons to the radioactive power generator to induce nuclear fission of the radioisotope material and thereby reenergize the radioactive power generator.

14. The method as set forth in claim 13, wherein the step or releasing the antiprotons comprises releasing the antiprotons from a penning trap generating a magnetic field.

15. The method as set forth in claim 14, wherein the step of releasing the antiprotons from the penning trap comprises moving one or more electrodes of the penning trap to free the antiprotons from the magnetic field in the penning trap.

16. The method as set forth in claim 15, wherein the step of moving one or more electrodes comprises using a direct current motor to drive a gear assembly to move the one or more electrodes.

17. The method as set forth in claim 15, wherein while powering the at least one electrical system for the initial interval of time, the method further comprises generating the magnetic field using a first endcap electrode, a second endcap electrode, and a ring electrode.

18. The method as set forth in claim 17, wherein the step of moving one or more electrodes comprises keeping the first endcap electrode stationary while moving the second endcap electrode to disrupt the magnetic field.

19. The method as set forth in claim 13, further comprising receiving a release signal at an antenna of the spacecraft after the initial period of time, and in response to the release signal, causing the antiprotons to be released.

20. The method as set forth in claim 13, further comprising inducing nuclear fission, powering the at least one electrical system of the spacecraft using the radioactive power generator for a subsequent time interval.
